(19) United States
(12) Patent Application Publication
(10) Pub. No.: US 2021/0239146 A1
(43) Pub. Date: Aug. 5, 2021

(54) JOINING ELEMENT, CONNECTION STRUCTURE WITH THE JOINING ELEMENT, MANUFACTURING METHOD OF THE JOINING ELEMENT AND CORRESPONDING CONNECTION METHOD

(71) Applicant: Böllhoff Verbindungstechnik GmbH, Bielefeld (DE)

(72) Inventors: Daniel Junklewitz, Paderborn (DE); Dennis Henke, Herzebrock-Clarholz (DE)

(21) Appl. No.: 17/167,706

(22) Filed: Feb. 4, 2021

(30) Foreign Application Priority Data
Feb. 5, 2020 (DE) DE102020102982.9

(51) Int. Cl. F16B 19/06; F16B 19/08; C21D 9/00

(52) U.S. Cl. CPC F16B 19/06; F16B 2019/045; C21D 9/0068; F16B 19/086

(57) ABSTRACT

A joining element for manufacturing a connection between at least two components, which includes: a head at a first axial end, an end portion at a second axial end opposite the first axial end, and a shaft arranged between the end portion and the head, wherein the shaft defines a longitudinal axis of the joining element between the first and the second axial end. At least the shaft and the end portion of the joining element comprise a hardened edge layer so that a material of the shaft and the end portion has in the interior a lower hardness compared to an adjacent surface of the edge layer.

### CROSS REFERENCE TO RELATED APPLICATIONS

This application claims the priority of German patent application No. DE102020102982.9, filed on Feb. 5, 2020. The entire content of this priority application is incorporated herein by reference in its entirety.

### TECHNICAL FIELD

The present disclosure relates to a joining element for establishing a connection between at least two components, a connection structure comprised of at least a first and a second component which are connected by means of the joining element, a manufacturing method of the joining element as well as a method for connecting at least a first component to a second component by means of the joining element.

### BACKGROUND

Joining elements for establishing a connection between two components usually comprise a head, a shaft as well as an end portion. The specific construction of the joining element depends on the desired field of application, so that joining elements are known in the prior art in a plurality of different designs.

DE 10 2010 025 359 A1, for example, describes a nail as a joining element for essentially rotation-free axial driving into at least one non-pre-punched component. The nail as a joining element comprises a nail head, a nail shaft and a nail tip, wherein the nail shaft comprises a surface profiling in some portions. The portion of the surface profiling has, according to its radial depth, a lower hardness than the nail shaft.

A further connection element, in particular a setting bolt, for connecting at least two components is disclosed in DE 10 2014 019 322 A1. The connection element comprises a pointed portion and a shaft portion the properties of which differ, wherein the connection element is formed in one piece. For example, the pointed portion has a higher strength than the shaft portion.

DE 103 28 197 B3 relates to a fastening element such as a bolt or nail. The fastening element comprises a shaft at the one end of which a tip is arranged and at the opposite other end a head is arranged. The fastening element comprises a core zone of a relatively hard, carbon containing steel and a ferritic edge zone of a less hard, low-carbon steel. A transition zone is arranged between the shaft and the tip, in which the thickness of the ferritic edge zone gradually decreases from the shaft towards the tip to a value close to zero.

A further fastening element is described in DE 10 2007 000 485 B3. The fastening element comprises an inner core zone of a relatively hard, carbon containing steel and an outer edge zone, relative to the core zone, of a first low-carbon austenitic steel alloyed with a first alloying metal. Between the core zone and the peripheral zone at least one first intermediate zone of a second low-carbon steel is arranged, which comprises a lower hardness than the steel of the core zone.

Finally, US 2003/014260 A1 also discloses a fastening element. This fastening element comprises a first tip-bearing shaft section with a greater hardness compared to a subsequent second shaft section.

With the known joining elements, components made of a material with a tensile strength of max. 600-800 MPa can currently be reliably joined within the scope of high-speed bolt setting. Starting from this strength class, the separation of a slug and/or failure of the joining element occurs. Thus, the known joining elements fail when translatorily set in a component made of high-strength or ultra-high-strength steel that has not been pre-punched in the joining portion, wherein the tip of the element should penetrate the component completely.

The object of at least some implementations of the present disclosure is therefore to provide a joining element with which the one-sided joining of components made of a high- or ultra-high-strength steel with a tensile strength in the range of more than 800 MPa can be realized in a one-step process without failure of the joining element and without separation of a slug. Furthermore, it is also an object of at least some implementations of the disclosure to provide a corresponding connection structure, a manufacturing method of the joining element and a method of connecting two components.

### SUMMARY

The above object is solved by a joining element, a connection structure, a manufacturing method of a joining element and a method of connecting at least a first component with a second component. Advantageous embodiments and further embodiments arise from the following description, the drawings as well as the appending claims.

A joining element for establishing a connection between at least two components comprises: a head at a first axial end, an end portion at a second axial end opposite the first axial end, and a shaft arranged between the end portion and the head, the shaft defining a longitudinal axis of the joining element between the first and the second axial end, wherein at least the shaft and the end portion of the joining element comprise a hardened edge layer, so that a material of the shaft and the end portion has in the interior a lower hardness compared to an adjacent surface of the edge layer.

The joining element thus comprises a head, a shaft and an end portion in a known manner. The end portion and the shaft in particular may be formed in one piece. The joining element as a whole may be formed in one piece, i.e. the head, the shaft and the end portion. Likewise, the joining element may be comprised of only one material. This applies in particular to the shaft and the end portion.

The extension of the shaft between the head and the end portion also defines in a usual manner the longitudinal axis of the joining element between the first and the second axial end, which is also referred to as the central longitudinal axis due to its position and course. The shaft may be formed cylindrically.

Furthermore, the joining element comprises the hardened edge layer. The advantage of this hardened edge layer is described in the following on the basis of a setting bolt as joining element. In this respect, the joining element may be selected from the group comprising the following: setting bolts, semi-hollow self-piercing rivets, solid self-piercing rivets, blind rivets and screws.

After the joining element has been manufactured in the usual manner, for example by cold forming, at least the shaft and the end portion, which may be the entire joining element, for example a setting bolt, are edge layer hardened in a further process step. Depending on the raw material or material of the joining element, high edge hardnesses of up to 1,200 HV 10 can be achieved—with a “soft and ductile” interior at the same time. With regard to the exemplary setting bolt as joining element, therefore, in particular the shaft is unchanged in the interior. In this context, a hardness of 1,200 HV 10 describes a Vickers hardness (HV) of 1,200 at a test force or applied force of 10 kilopond.

An advantage of these edge layer hardened joining elements results when the joining element, i.e. for example the setting bolt, is to be set in the component made of high or ultra-high strength steel. Thus, the e joining element can be placed in a component made of a steel with a tensile strength of over 800 MPa, or over 1,200 MPa and up to 2,000 MPa or at least up to 1,500 MPa without separation of a slug and without deformation of the end portion.

In addition to that the process window has been extended, there is also an increased notched bar impact work and thus ductility, which can be attributed to the soft interior of the joining element compared to the hardened edge layer. The notched bar impact work or notched bar impact strength is a measure for the abrupt and/or dynamic stress of the joining element. This stress occurs not only during the joining process but also in the later connection structure if the joining element has to hold the at least two components together under component loads. This increased notched bar impact work or notched bar impact strength has an advantageous effect with regard to the connection made with the joining element, since, for example, larger temperature differences during further processing of the connection or mechanical loads on the connection structure are tolerated by the joining element without any disadvantageous influence on the connection.

In an embodiment of the joining element, at least the material of the shaft and the end portion is quenched and tempered. In this way, the hardness of the edge layer can, depending on the procedure used to create the edge layer, be further increased compared to a non-quenched and non-tempered material. Quenching and tempering refers to the combined heat treatment of metals such as steel, consisting of hardening and subsequent tempering. The prerequisite for quenching and tempering is therefore the hardenability of the steel used, i.e. the ability to form a stable martensite or bainite structure under certain conditions. For hardening itself, the steel may be heated quickly above the austenitizing temperature. Afterwards, the steel is quenched, that is, the heated material cools down rapidly, by using quenching agents, such as water, oil (polymer bath) or air. Finally, a tempering or blue-annealing process takes place, which is a heat treatment in which the steel is specifically heated to influence its properties, in particular to reduce stresses.

Furthermore, the hardening of the edge layer may be achieved by nitriding, induction hardening, flame hardening, laser beam hardening, electron beam hardening or carburizing. Here nitriding, especially gas nitriding may be used. Especially nitriding allows the joining elements to be hardened to be processed as bulk material, which in addition to advantageous processing times also results in an economical processing method.

In a further embodiment of the joining element, at least the shaft and the end portion of the joining element, which may be the entire joining element, comprises a coating of a material that provides a greater hardness than the material of the shaft and the end portion. Instead of using the material of the joining element, a separate coating is used here to produce the hardened edge layer. The resulting technical effects may correspond to the technical effects already discussed above.

A connection structure is comprised of at least a first component and a second component, which are connected by means of the joining element. With regard to the resulting advantages and technical effects, reference is therefore made to the above explanations on the joining element in order to avoid unnecessary repetitions.

In a further embodiment of the connection structure, the first component is arranged adjacent to the head and the second component adjacent to the end portion of the joining element, wherein the second component is comprised of a steel, such as a hot forming steel, with a tensile strength of at least 800 MPa, in particular with a tensile strength between 800 MPa and 2,000 MPa or at least between 800 MPa and 1,500 MPa. It is precisely the specific design with the outer hard edge portion and the in comparison thereto softer core of the joining element that ensures that no slugs are separated from the second component made of steel with a tensile strength of at least 800 MPa. In this way, disadvantageous noise generation is also avoided.

A manufacturing method of the joining element comprises the following steps: providing, in particular by cold forming or turning, the joining element having a head at a first axial end, an end portion at a second axial end opposite the first axial end, as well as a shaft arranged between the end portion and the head, which defines a longitudinal axis of the joining element between the first and the second axial end, and hardening at least the shaft and the end portion of the joining element so that the shaft and the end portion comprise a hardened edge layer, whereby a material of the shaft and the end portion has in the interior a lower hardness compared to a radially adjacent surface. The joining element described above is manufactured according to the manufacturing method. With regard to the advantages and the resulting technical effects, reference is therefore made to the above explanations in order to avoid repetitions.

In a further embodiment of the manufacturing method, this comprises the following step before the joining element is hardened: quenching and tempering of at least the shaft and the end portion of the joining element. An advantage of this procedure is that the hardness of the later edge layer, especially when using a method such as nitriding, can be further increased compared to a non-quenched and non-tempered material for the joining element.

The manufacturing method may comprise within the step of hardening the following: nitriding, induction hardening, flame hardening, laser beam hardening, electron beam hardening or carburizing or applying a coating at least at the shaft and the end portion of the joining element. For the advantages of the respective methods, reference is made to the above explanations.

Advantageously, a material for the joining element comprises a cold-formable steel. In this way, a setting bolt, for example, can be cost-effectively manufactured as a joining element by cold forming.

The method for connecting at least a first component to a second component by means of the joining element comprises the following steps: arranging the first and the second component one above the other, setting the joining element in the arrangement of the first and the second component arranged one above the other, wherein the setting of the joining element may be carried out essentially rotation-free. The essentially rotation-free setting can also be described as exclusively translational setting of the joining element. This setting is carried out in the components that are not pre-punched in the joining portion and which are to be connected with each other. At the end of the setting process, the end portion of the joining element, depending on the joining element used, may have penetrated both components, but at least the component facing the head. Regarding the resulting advantages, reference is made to the above explanations on the joining element in order to avoid repetitions.

The first component may be arranged adjacent to the head and the second component may be arranged adjacent to the end portion of the joining element, wherein the second component is comprised of a steel, such as a hot forming steel, with a tensile strength of at least 800 MPa, in particular with a tensile strength between 800 MPa and 2,000 MPa or at least between 800 MPa and 1,500 MPa. As explained at the beginning, there is a risk in the case of such a component that the end portion of the joining element will be plastically deformed. This risk may be minimized or eliminated due to the hardened edge layer.

In a further embodiment of the method, the first component is arranged adjacent to the head and the second component is arranged adjacent to the end portion of the joining element, wherein a penetration of the second component occurs without the separation of a punch slug. It is precisely the specific design with the outer hard edge portion and the in comparison thereto softer core material of the joining element that makes it possible that no slug is separated from the second component made of steel with a tensile strength of at least 800 MPa. In this way, disadvantageous noise generation is also avoided.

### BRIEF DESCRIPTION OF THE DRAWINGS

In the following, the present disclosure is described in detail with reference to the drawings. The same reference signs in the drawings indicate the same components and/or elements. Showing:

FIG. 1 a cross-section of a joining element,

FIG. 2 a perspective view of a joining element set in a component made of high or ultra-high strength steel,

FIG. 3 a perspective view of a joining element set in a component made of high or ultra-high strength steel,

FIG. 4 a perspective view of a joining element set in a component made of high or ultra-high strength steel,

FIG. 5 a micrograph or microsection of an end portion of an embodiment of the joining element,

FIG. 6 a diagram for illustrating the hardened edge portion,

FIG. 7 a diagram of notched bar impact work as well as hardness,

FIG. 8 a flow chart of an embodiment of a manufacturing method of the joining element, and

FIG. 9 a flow chart of an embodiment of a method for connecting two components with the joining element.

### DETAILED DESCRIPTION

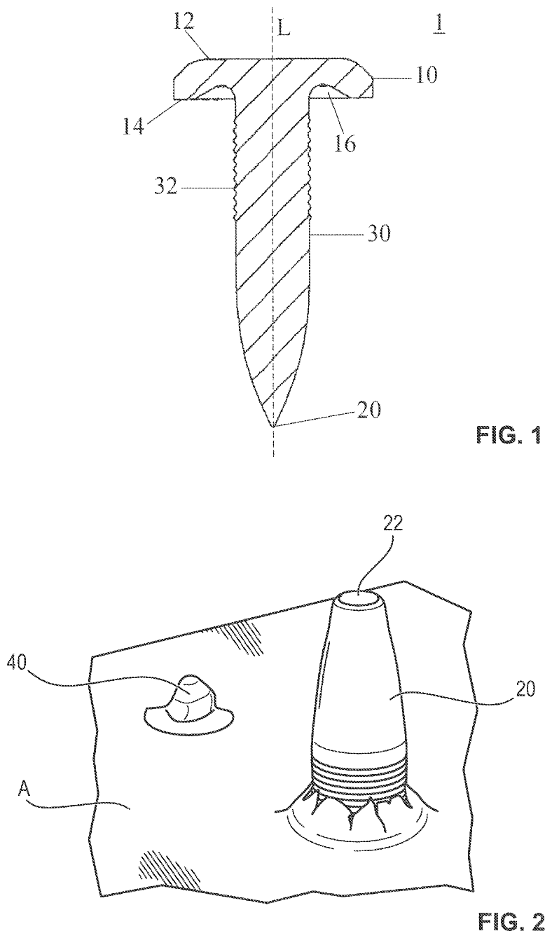

Referring to FIG. 1, a joining element 1 is shown in the form of a setting bolt. With regard to the details of the form, reference is made to DE 10 2006 002 238 A1, the content of which is incorporated by reference in this respect.

Instead of the setting bolt as joining element 1, semi-hollow self-piercing rivets, solid self-piercing rivets, blind rivets, screws and the like can also be used as joining elements and the following description applies accordingly to these joining elements. With regard to the details of the shape, reference is made to DE 10 2012 102 860 A1, DE 10 2015 118 888 A1 and DE 10 2019 102 383 A1 for semi-hollow self-piercing rivets, DE 10 2018 128 455 and DE 10 2019 102 380 for solid self-piercing rivets and DE 20 2005 005 536 Ul and EP 1 710 454 A1 for blind rivets, which are also incorporated by reference in this respect.

Referring again to FIG. 1, the joining element 1 comprises in a known manner a head 10 at a first axial end, an end portion 20, in this case a tip, at a second axial end as well as a shaft 30 arranged in between. The shaft 30 defines a longitudinal axis L of the joining element 1 between the first and the second axial end, which due to its position can also be referred to as the central longitudinal axis.

The head 10 of joining element 1 comprises a flat upper side 12, a cylindrical circumferential face and a flat underside 14. The flat underside 14 has an annular groove 16 adjacent to the shaft 30 for receiving a bead- or bulge-shaped material accumulation of the head-side component, which is particularly advantageous when setting the joining element 1 into at least two components.

The annular groove 16 comprises a rounded circumferential face adjacent to the shaft 30, which transitions tangentially into the shaft 30 on the one hand and into a conical face on the other. In this way, especially when the material of the component facing the head rises against the joining direction, the material can be accommodated in the annular groove 16.

The shaft 30 is formed cylindrically and, at least in a subportion, has a surface profiling 32 for receiving material, of the component A facing away from the head. In this way, the joining element 1 may be reliably fastened in at least one component.

The end portion 20, in this case the tip, directly adjoins the shaft 30.

Now referring to FIG. 2, which shows a perspective view of a joining element set in the component made of high or ultra-high strength steel, the disadvantages of the known joining elements are explained. The joining element used comprises a hardness of 450 HV 10, that is, a Vickers hardness (HV) of 450 at a test force or applied force of 10 kilopond. Due to the high tensile strength of the component made of high-strength or ultra-high-strength steel, the use of the known joining element results in plastic deformation of the end portion 26 of the joining element. In addition, a slug 40 is separated from the component. However, this is disadvantageous due to the noise development even if the component is only accessible from one side. Overall, the connection made in this way can therefore be categorized as not being acceptable.

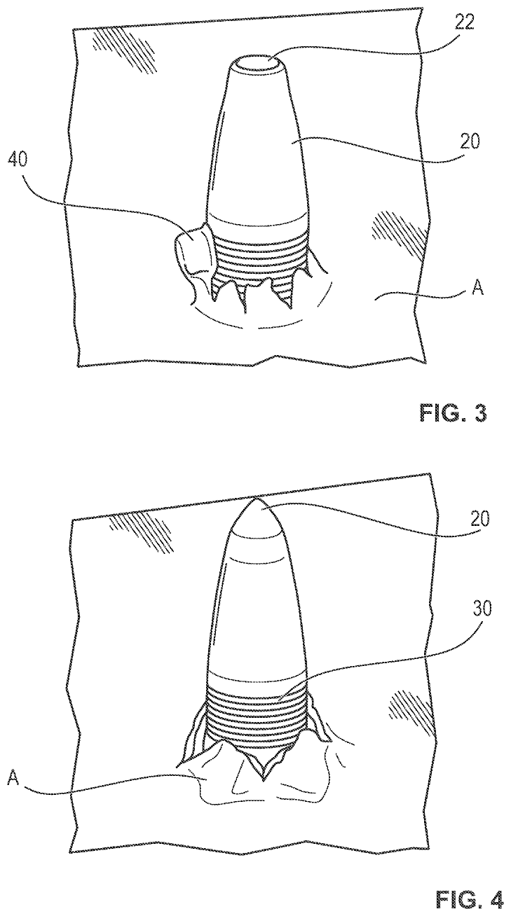

FIG. 3 shows a perspective view of another joining element set into a component made of high or ultra-high strength steel. The joining element used here comprises the hardness class 8 with a hardness of 600 HV 10. The increase in the hardness of the joining element resulted not only in an increase in brittleness, but also in a reduction of the deformation of the end portion. As can be seen from FIG. 3, the slugs remain at the eyelet. In this case, in particular dynamic loads could cause a loosening of the slug. This can in turn, especially with regard to the manufacturing of a motor vehicle body, lead to damage to the cathodic dip coating layer, so that there is no corrosion protection in this portion when the component is further processed with the joining element. Thus, this connection is also disadvantageous as it is not suitable for possible further processing steps or downstream processing steps.

Now referring to FIG. 4, a perspective view of a joining element according to an embodiment set into a component made of high-strength or ultra-high-strength steel is shown. Therefore, at least the shaft and the end portion of the joining element, which may be the entire joining element, comprises a hardened edge portion 24. The use of the hardened edge portion 24 results in hardnesses of up to 1,200 HV 10 being achievable, depending on the material used for the joining element.

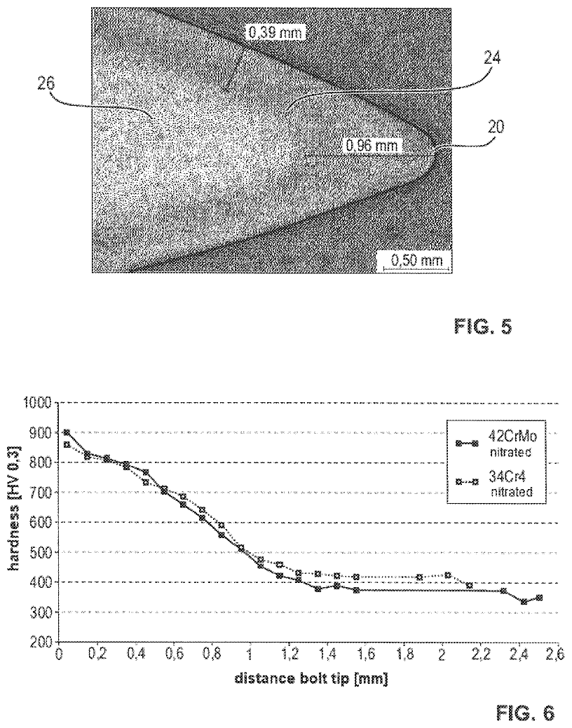

FIG. 5 shows a micrograph or microsection of the end portion 20 of the joining element to illustrate the modification in the material. The hardening of the edge portion 24 was achieved by nitriding, especially gas nitriding. Apart from nitriding, any method in which the joining elements provided may be further processed as bulk material, i.e. where no individual processing is required.

As can be seen from FIG. 5 in connection with FIG. 6, the hardened edge portion 24 extends into the interior of the joining element to a depth of approx. 1.2 mm. The hardness curve or progression is shown in FIG. 6 for the two joining element materials 34Cr4 and 42CrMo4. By nitriding, hardnesses of up to 900 HV 0.3 were achieved for these materials, which decrease linearly towards the core. The nitriding depth, i.e. the depth of the hardened edge layer 24, can be reliably adjusted by means of the nitriding duration.

By using edge layer hardened joining elements, steel materials with a tensile strength of 1,200 MPa are joinable without separation of a slug and without deformation of the end portion. In addition, for example steels such as hot forming steels with a tensile strength of up to 2,000 MPa, for example 1,500 MPa, can be joined in thicknesses of approx. 1.2 mm.

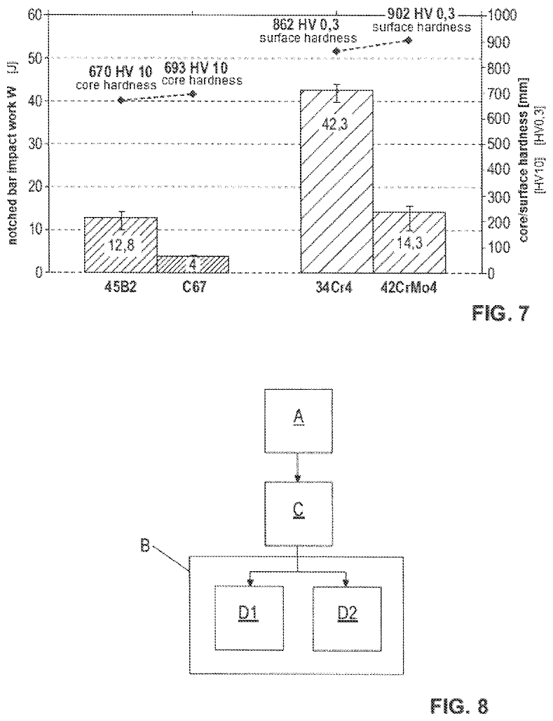

In addition to that the process window has been extended when setting the joining element, there is also an increased notched bar impact work and thus an increased ductility. The notched bar impact work or notched bar impact strength is a measure for the abrupt and/or dynamic stress of the joining element. This stress occurs not only during the joining process but also in the later connection structure if the joining element has to hold the at least two components together under component loads. This increased notched bar impact work or notched bar impact strength can be attributed to the core 26 in the interior of the joining element 1, which is soft compared to the hardened edge portion 24. For example, by changing the material from C67 to 34Cr4 and using the nitriding process, the notched bar impact work can be increased tenfold, as shown in FIG. 7, taking into account different materials.

One advantage of this attribute has an effect on the later connection structure. The combination of a hard edge portion and a relatively soft core results in the joining element being reliably fastened in subsequent processing steps despite the hardened edge portion. This applies, for example, with regard to a later artificial ageing of two components joined by means of the joining element.

A connection structure in which the joining element is used, for example, is comprised of a first component facing the head and a second component facing away from the head. The components are connected by means of an embodiment of the joining element. Here, an end portion of the joining element can penetrate both components. Alternatively, the end portion of the joining element is arranged in the component facing away from the head. Similarly, the joining element can only be set into one of the components and subsequently be welded to the second component.

One of the components, in particular the component B facing away from the head, may be comprised of a steel with a tensile strength of at least 800 MPa. Thus, the component B facing away from the head or the lower component B was manufactured from a high-strength or ultra-high-strength steel. Due to the specific design of the joining element, the risk of plastic deformation of the end portion 20 as well as of a fracture of the joining element may be reduced or eliminated when setting the joining element in such a component B as well as when penetrating component B, as explained above. In addition, the joining element prevents a slug from being separated or cut off from the second component made of steel with a tensile strength of at least 800 MPa.

FIG. 8 shows a flow chart of an embodiment of a manufacturing method of a joining element. The joining element may be comprised of a cold-formable steel at least at the shaft and the end portion. In addition, the joining element was advantageously selected from the following group: setting bolts, semi-hollow self-piercing rivets, solid self-piercing rivets, blind rivets, screws and the like.

In the course of manufacturing, in a first step A, a providing, which may be by cold forming or turning, of the joining element having a head at a first axial end, an end portion at a second axial end opposite the first axial end, as well as a shaft arranged between the end portion and the head takes place, wherein the shaft defines a longitudinal axis of the joining element between the first and the second axial end.

In an optional step C, a quenching and tempering of at least the shaft and the end portion of the joining element, of the joining element as a whole, is then carried out. For details on quenching and tempering, reference is made to the above explanations.

In a final step B, hardening of at least the shaft and the end portion of the joining element, of the joining element as a whole, may take place so that the shaft and the end portion comprise a hardened edge layer, whereby a material of the shaft and the end portion has in the interior a lower hardness compared to a radially adjacent surface. The hardening step comprises either one of nitriding, induction hardening, flame hardening, laser beam hardening, electron beam hardening or carburizing (step D1) or the hardening step comprises applying a coating at least at the shaft and the end portion of the joining element (step D2). In this way, the joining element described above is manufactured according to one embodiment.

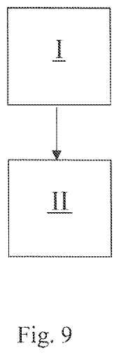

Finally, and with reference to FIG. 9, a flow chart of an embodiment of a method for connecting a first component A to a second component B by means of an embodiment of a joining element is shown. In a first step I, an arranging of the first A and the second component B one above the other is performed. In a subsequent second step II, a setting of the joining element into the arrangement of the first and the second component arranged one above the other takes place, wherein the setting of the joining element is essentially rotation-free. The essentially rotation-free setting can also be described as an exclusively translatory setting of the joining element.

The first component is arranged adjacent to the head and the second component is arranged adjacent to the tip of the joining element during setting and both components are not pre-punched in the joining portion, as already discussed. The second component may be comprised of a steel with a tensile strength of at least 800 MPa. A penetration of the second component B takes place without separation of a slug. It is precisely the specific design of the joining element that makes it possible that no slug is separated from the second component made of steel with a tensile strength of at least 800 MPa.

1. A joining element for manufacturing a connection between at least two components, which comprises:
a. a head at a first axial end,
b. an end portion at a second axial end opposite the first axial end as well as
c. a shaft arranged between the end portion and the head, wherein the shaft defines a longitudinal axis of the joining element between the first and the second axial end, wherein
d. at least the shaft and the end portion of the joining element comprise a hardened edge layer, so that a material of the shaft and the end portion has in the interior a lower hardness compared to an adjacent surface of the edge layer.

2. The joining element according to claim 1, wherein at least the material of the shaft and the end portion is quenched and tempered.

3. The joining element according to claim 1, selected from the group consisting of: setting bolts, semi-hollow self-piercing rivets, solid self-piercing rivets, blind rivets and screws.

4. The joining element according to claim 1, wherein the hardening of the edge layer was achieved by nitriding, induction hardening, flame hardening, laser beam hardening, electron beam hardening or carburizing.

5. The joining element according to claim 1, wherein at least the shaft and the end portion of the joining element comprise a coating of a material providing a hardness greater than the material of the shaft and the end portion.

6. The joining element according to claim 2, selected from the group consisting of: setting bolts, semi-hollow self-piercing rivets, solid self-piercing rivets, blind rivets and screws.

7. The joining element according to claim 2, wherein the hardening of the edge layer was achieved by nitriding, induction hardening, flame hardening, laser beam hardening, electron beam hardening or carburizing.

8. The joining element according to claim 2, wherein at least the shaft and the end portion of the joining element comprise a coating of a material providing a hardness greater than the material of the shaft and the end portion.

9. The joining element according to claim 3, wherein the hardening of the edge layer was achieved by nitriding, induction hardening, flame hardening, laser beam hardening, electron beam hardening or carburizing.

10. The joining element according to claim 3, wherein at least the shaft and the end portion of the joining element comprise a coating of a material providing a hardness greater than the material of the shaft and the end portion.

11. The joining element according to claim 4, wherein at least the shaft and the end portion of the joining element comprise a coating of a material providing a hardness greater than the material of the shaft and the end portion.

12. A connection structure comprised of at least a first component and a second component connected by a joining element according to claim 1.

13. The connection structure according to claim 12, in which the first component is arranged adjacent to the head and the second component is arranged adjacent to the end portion of the joining element, wherein the second component is comprised of a steel, in particular a hot forming steel, having a tensile strength of at least 800 MPa, in particular having a tensile strength between 800 MPa and 2,000 MPa or at least between 800 MPa and 1,500 MPa.

14. A manufacturing method of a joining element according to claim 1, comprising the following steps:
a. providing, in particular by cold forming or turning, the joining element having a head at a first axial end, an end portion at a second axial end opposite the first axial end, as well as a shaft arranged between the end portion and the head, wherein the head defines a longitudinal axis of the joining element between the first and the second axial end, and
b. hardening of at least the shaft and the end portion of the joining element so that the shaft and the end portion comprise a hardened edge layer, whereby a material of the shaft and the end portion has in the interior a lower hardness compared to a radially adjacent surface.

15. The manufacturing method according to claim 14, which comprises the further step before the hardening of the joining element:
c. quenching and tempering of at least the shaft and the end portion of the joining element.

16. The manufacturing method according to claim 14, wherein the step of hardening comprises:
d1. nitriding, induction hardening, flame hardening, laser beam hardening, electron beam hardening or carburizing; or
d2. applying a coating at least at the shaft and the end portion of the joining element.

17. The manufacturing method according to claim 14, wherein the joining element is selected from the group consisting of: setting bolts, semi-hollow self-piercing rivets, solid self-piercing rivets, blind rivets and screws.

18. The manufacturing method according to claim 14, wherein a material for the joining element comprises a cold-formable steel.

19. The manufacturing method according to claim 15, wherein the step of hardening comprises:
d1. nitriding, induction hardening, flame hardening, laser beam hardening, electron beam hardening or carburizing; or
d2. applying a coating at least at the shaft and the end portion of the joining element.

20. The manufacturing method according to claim 15, wherein the joining element is selected from the group consisting of: setting bolts, semi-hollow self-piercing rivets, solid self-piercing rivets, blind rivets and screws.
